(19) United States
(12) Patent Application Publication
(10) Pub. No.: US 2012/0194660 A1
(43) Pub. Date: Aug. 2, 2012

(54) IMAGE DISPLAY DEVICE AND STEREO IMAGE DISPLAY SYSTEM

(76) Inventors: Tatsunori Nakamura, Osaka-shi (JP); Takeshi Kumakura, Osaka-shi (JP); Makoto Shiomi, Osaka-shi (JP)

(21) Appl. No.: 13/499,950

(22) PCT Filed: Oct. 13, 2010
(86) PCT No.: PCT/JP2010/067972

§ 371 Date: Apr. 3, 2012

(30) Foreign Application Priority Data
Oct. 19, 2009 (JP) 2009-240005

(51) Int. Cl. H04N 13/04

(52) U.S. Cl. 348/56; 348/54; 348/E13.075

(57) ABSTRACT

An image display device that provides stereo image display with the help of special glasses (i.e. a vision aid) and that allows a viewer looking at the screen without such a vision aid to view a less strange image, and a stereo image display system including such an image display device are provided. The image display device includes: a display module capable of displaying a left eye image (L) to be viewed via a left eye portion of the vision aid and a right eye image (R) to be viewed via a right eye portion of the vision aid, the left eye and right eye images being displayed separately in time and space; and an average brightness controller capable of regulating an average brightness of the left eye image and an average brightness of the right eye image displayed on the display module in one given frame such that these average brightnesses are different from each other.

### TECHNICAL FIELD

The present invention relates to an image display device which, in combination with a vision aid, allows a viewer to view a stereo image, and a stereo image display system including the image display device and the vision aid.

### BACKGROUND ART

In recent years, increasingly active research and development efforts have been made to put into practical use stereo image display systems that allow a viewer to view a stereoscopic image.

Conventional stereo image display systems are generally classified into: (1) so-called glasses-based stereo image display systems, where right and left eye images with a parallax are displayed on an image display device and special glasses (i.e. a vision aid), worn by a viewer, allow the viewer to view only left eye images with his left eye and to view only right eye images with his right eye; and (2) so-called naked-eye stereo image display systems, which allow the viewer to view a stereo image without special glasses.

Glasses-based stereo image display systems in (1) above are further subdivided into several types. For example, the following methods are known: (a) the so-called anaglyph method, which generates left eye images and right eye images in two different colors (for example, red and blue) and employs glasses with a red color filter for one eye and a blue color filter for the other eye (see, for example, JP2006-129225A); (b) methods that display left eye images and right eye images in different polarization states and employ glasses with polarizing filters for separating right and left eye images from each other (see, for example, JP2008-292577A, paragraphs 0038 to 0054); and (c) methods that alternately display a left eye image and then a right eye image and employ liquid crystal shutter glasses in which the left and right portions are alternately opened and closed in synchronization with the switching of images (see, for example, JP2008-292577A, paragraphs 0055 to 0066).

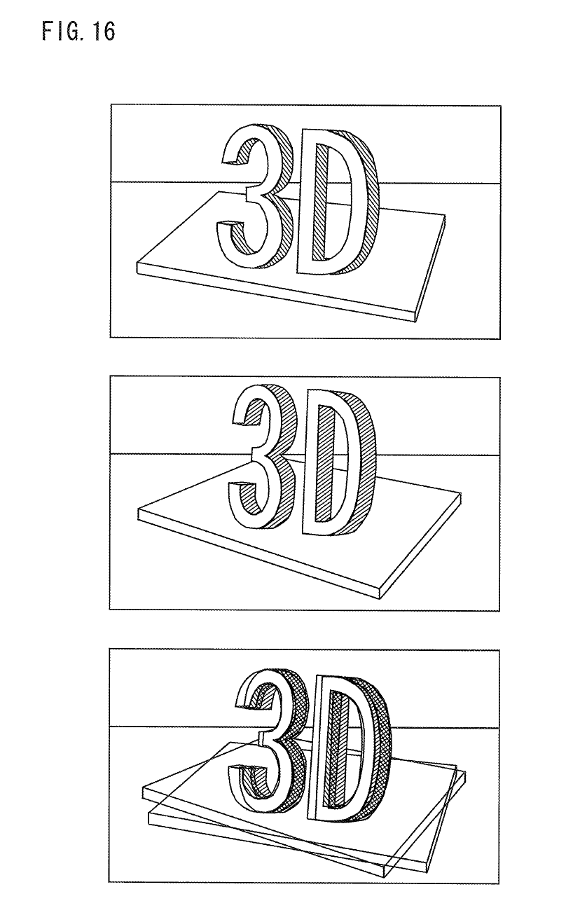

However, one problem with glasses-based stereo image display systems is that, if a person without special glasses for these systems views the screen, he sees left and right eye images superimposed on each other. Specifically, if a left eye image shown in FIG. 16(a) and a right eye image shown in FIG. 16(b) are displayed on the image display device to display a stereo image and the viewer views them without special glasses, the viewer sees the left and right eye images superimposed on each other with their contours being offset, as shown in FIG. 16(c).

### DISCLOSURE OF THE INVENTION

In view of the above problems, an object of the present invention is to provide an image display device that achieves stereo image display with the help of special glasses (i.e. a vision aid) and that allows a person seeing the screen without such a vision aid to view a less strange image, and a stereo image display system including such an image display device.

To achieve the above object, an image display device according to the present invention includes: a display module capable of displaying a left eye image to be viewed via a left eye portion of a vision aid and a right eye image to be viewed via a right eye portion of the vision aid, the left eye and right eye images being displayed separately in time and space; and an average brightness controller capable of regulating an average brightness of the left eye image and an average brightness of the right eye image displayed on the display module in one given frame such that these average brightnesses are different from each other.

Further, a stereo image display system according to the present invention is a stereo image display system including an image display device and a vision aid, the image display device including: a display module capable of displaying a left eye image to be viewed via a left eye portion of the vision aid and a right eye image to be viewed via a right eye portion of the vision aid, the left eye and right eye images being displayed separately in time and space; and an average brightness controller capable of regulating an average brightness of the left eye image and an average brightness of the right eye image displayed on the display module in one given frame such that these average brightnesses are different from each other, the vision aid including: an image selector capable of allowing only the left eye image to pass through the left eye portion and allowing only the right eye image to pass through the right eye portion.

Furthermore, a vision aid according to the present invention is a vision aid including two shutters that can be opened and closed independently from each other, one at a left eye portion and the other at a right eye portion, including an image selector capable of allowing only a left eye image to pass through the left eye portion and allowing only a right eye image to pass through the right eye portion, the left eye image and the right eye image being displayed, on a display module of an image display device, separately in time and space so as to have different average brightnesses in one given frame.

According to the present invention, an image display device that achieves stereo image display with the help of a vision aid and that allows a person seeing the screen without such a vision aid to view a less strange image, and a stereo image display system including such an image display are provided.

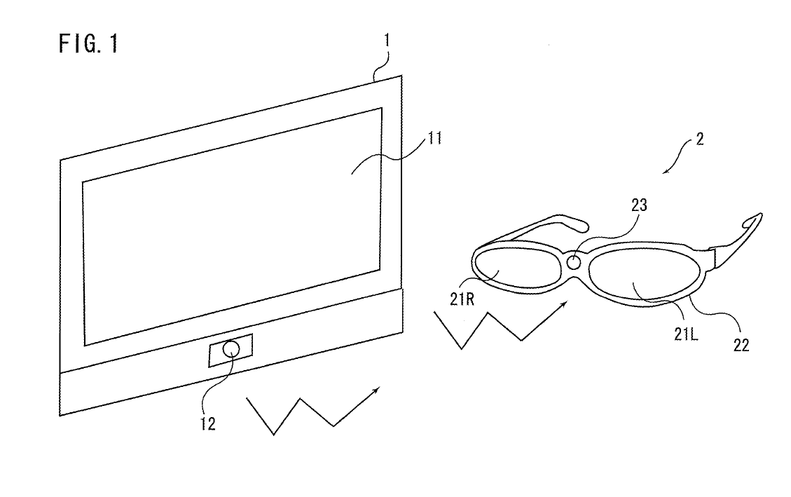

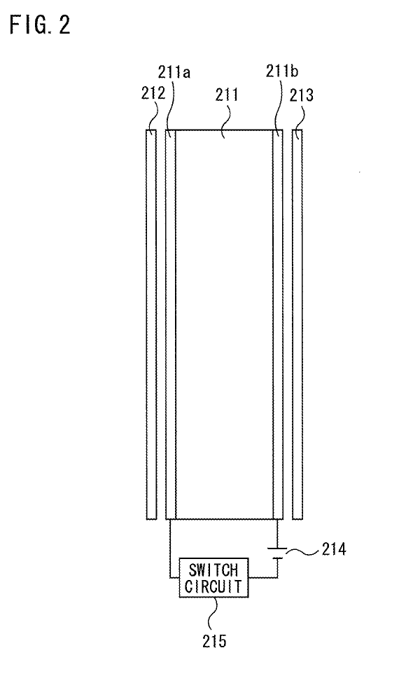

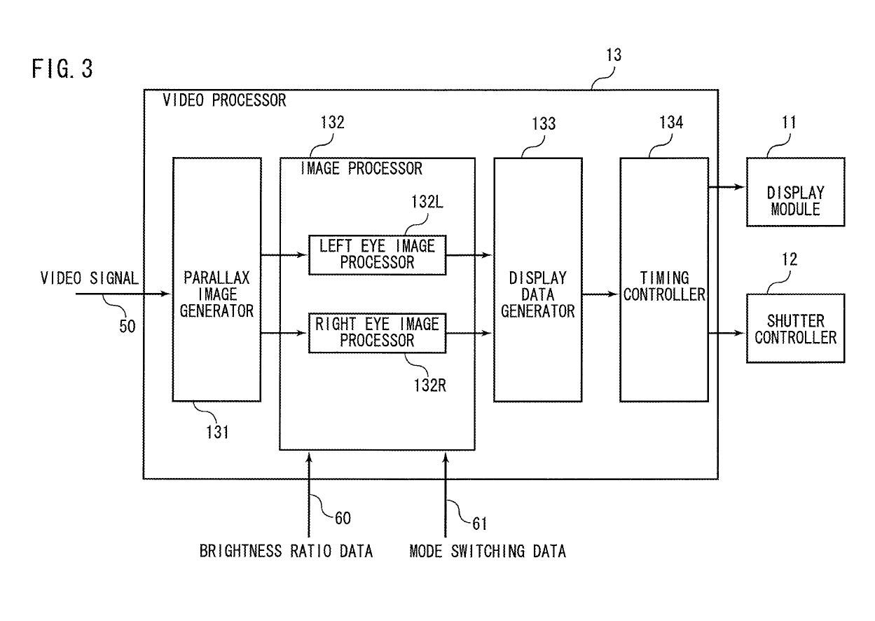

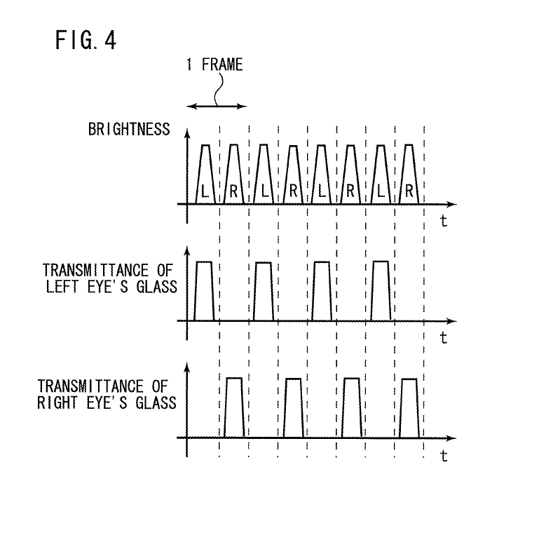

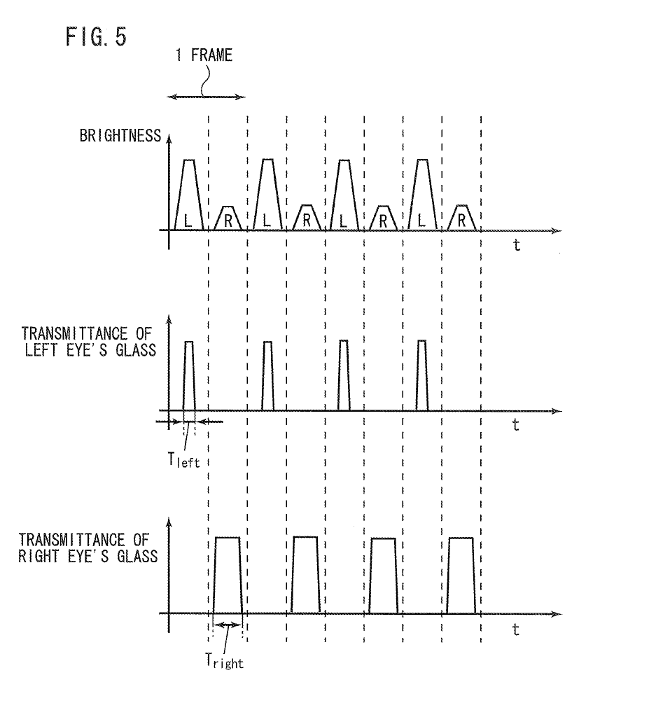

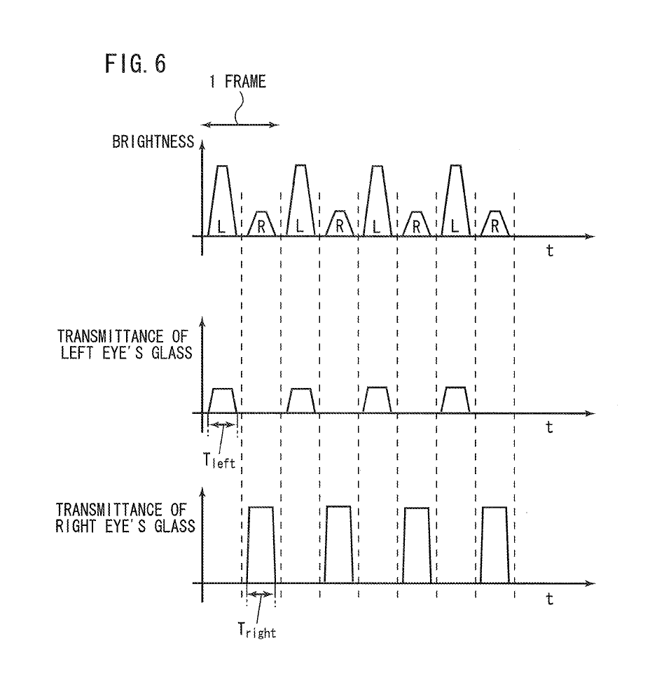

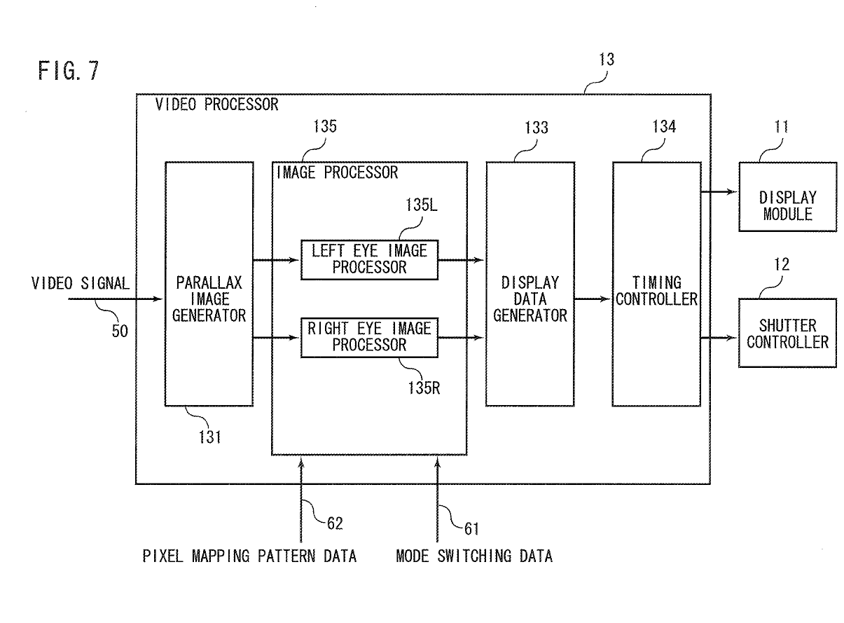

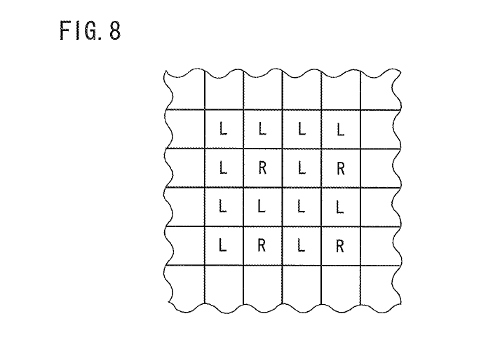

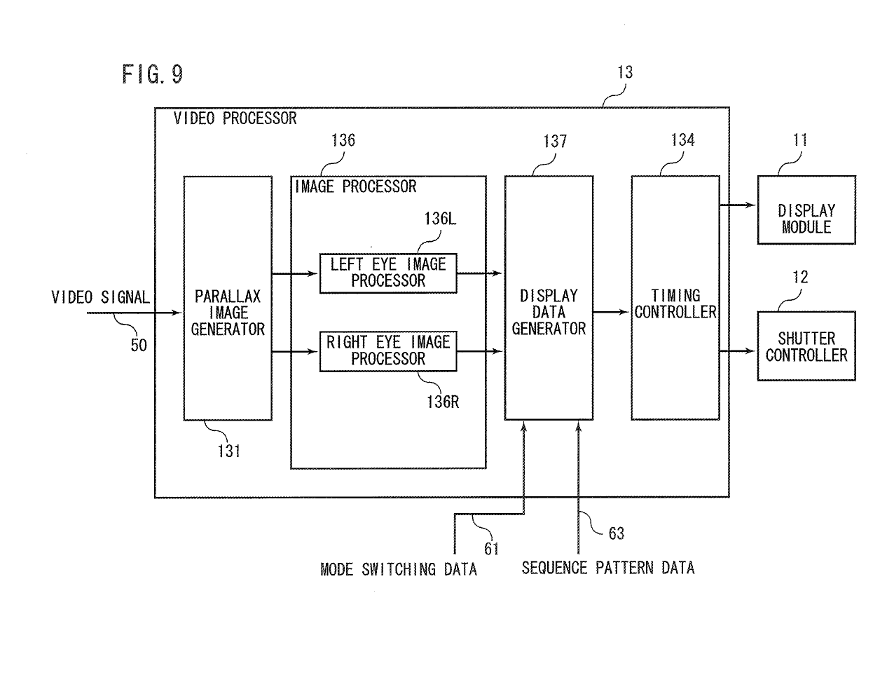

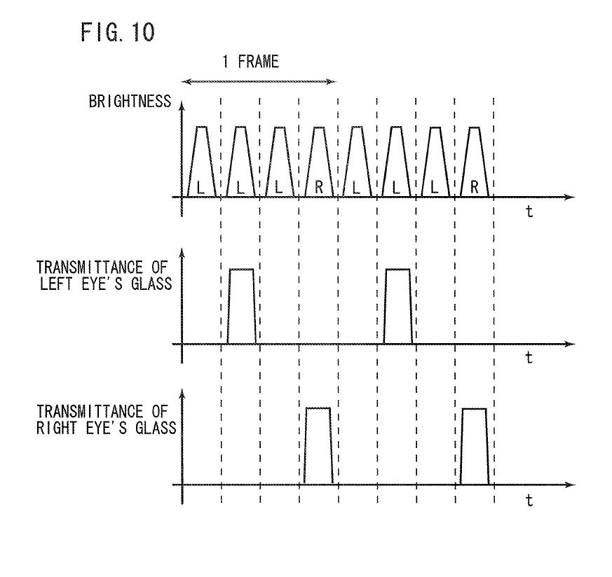

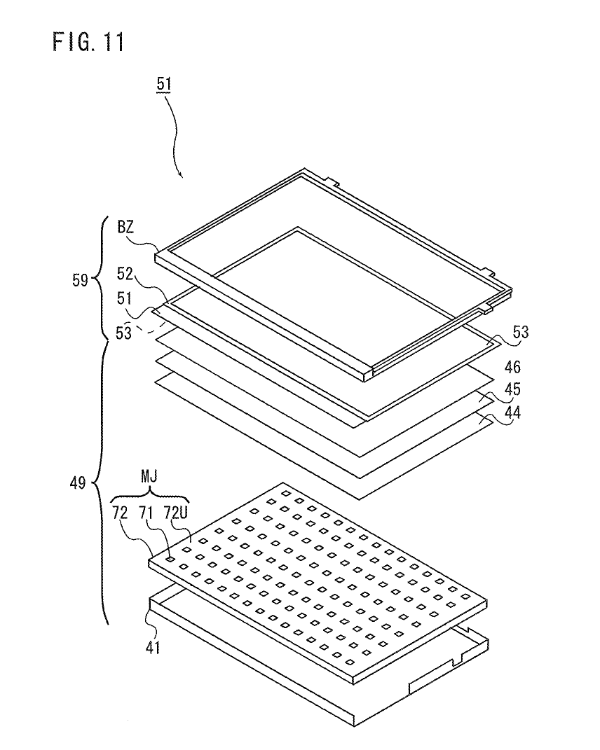

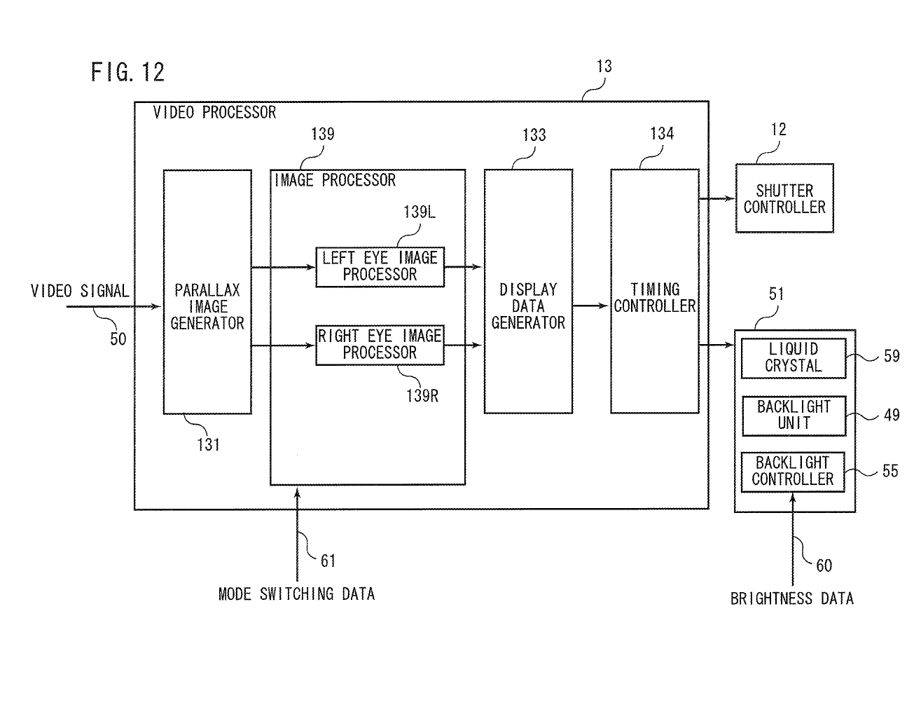

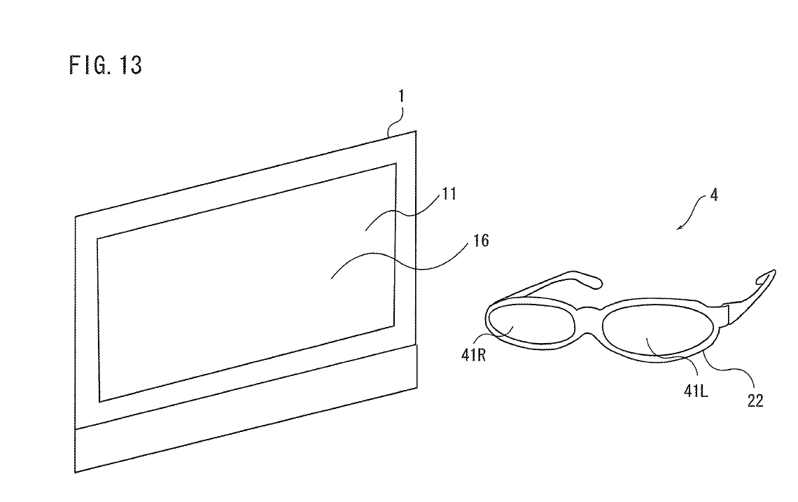

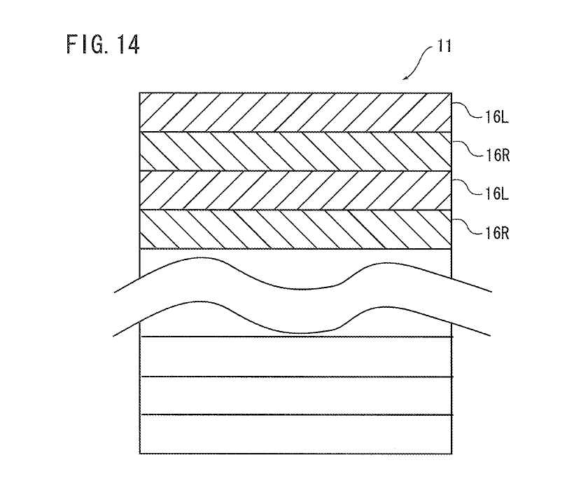

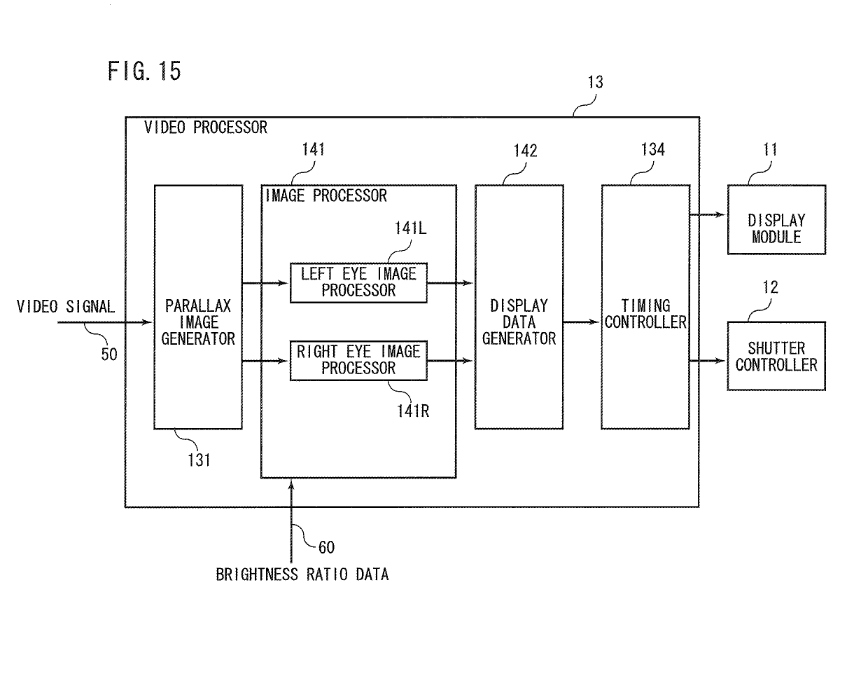

### BRIEF DESCRIPTION OF THE DRAWINGS

[FIG. 1] FIG. 1 is a schematic view of an entire stereo image display system according to a first embodiment of the present invention.

[FIG. 2] FIG. 2 is a schematic cross-sectional view of shutter glasses according to the first embodiment.

[FIG. 3] FIG. 3 is a block diagram illustrating the functional configuration of the image display device according to the first embodiment.

[FIG. 4] FIG. 4 illustrates the timing of image display and the timing of the opening and closing of the liquid crystal shutters of the shutter glasses performed when the 3D-only mode is selected.

[FIG. 5] FIG. 5 illustrates the timing of image display and the timing of the opening and closing of the liquid crystal shutters of the shutter glasses performed when the 2D/3D dual purpose mode is selected.

[FIG. 6] FIG. 6 illustrates the timing of the opening and closing of the liquid crystal shutters of shutter glasses according to a second embodiment.

[FIG. 7] FIG. 7 is a block diagram illustrating the functional configuration of an image display device according to a third embodiment.

[FIG. 8] FIG. 8 is a plan view of a pixel arrangement in the display module of the image display device according to the third embodiment.

[FIG. 9] FIG. 9 is a block diagram illustrating the functional configuration of an image display device according to a fourth embodiment.

[FIG. 10] FIG. 10 illustrates the timing of image display and the timing of the opening and closing of the liquid crystal shutters of the shutter glasses performed when the 3D-only mode is selected.

[FIG. 11] FIG. 11 is an exploded perspective view of a display module 51 according to a fifth embodiment.

[FIG. 12] FIG. 12 is a block diagram schematically illustrating the image display device according to the fifth embodiment.

[FIG. 13] FIG. 13 is a schematic view of an entire stereo image display system according to a sixth embodiment.

[FIG. 14] FIG. 14 is a schematic view of the screen configuration of the display module of the image display device according to the sixth embodiment.

[FIG. 15] FIG. 15 is a block diagram schematically illustrating the functional configuration of the image display device according to the sixth embodiment.

[FIG. 16] FIG. 16 illustrates a left eye image (a), a right eye image (b) and how they appear when they are viewed by naked eyes (c).

### EMBODIMENTS FOR CARRYING OUT THE INVENTION

An image display device according to an embodiment of the present invention includes: a display module capable of displaying a left eye image to be viewed via a left eye portion of a vision aid and a right eye image to be viewed via a right eye portion of the vision aid, the left eye and right eye images being displayed separately in time and space; and an average brightness controller capable of regulating an average brightness of the left eye image and an average brightness of the right eye image displayed on the display module in one given frame such that these average brightnesses are different from each other. Average brightness as used herein means the amount of light emitted per unit area of the display (i.e. the display module 11).

According to this arrangement, the average brightness controller regulates the average brightness of a left eye image and that of a right eye image displayed on the display module in one given frame such that these average brightnesses are different from each other, thereby making one of the left eye and right eye images more visible than the other to a viewer without a vision aid. This mitigates the situation of the left eye and right eye images being visible as superimposed offset images. As a result, an image display device is realized that allows a person viewing the screen without a vision aid to view a less strange image. The vision aid is a special instrument that allows the left eye to see left eye images only and the right eye to see right eye images only, and may be, for example: (a) liquid crystal shutter glasses used in an implementation where the image display device alternately displays a left eye image and a right eye image, in which the left and right portions are alternately opened and closed in synchronization with the switching of images; and (b) glasses used in an implementation where the image display device alternately displays a left eye image and a right eye image in different polarization states and including polarizing filters to separate the left and right images from each other.

In the above image display device, the average brightness controller may include: an image processor that generates left eye image display data and right eye image display data such that a maximum brightness of the left eye image is different from a maximum brightness of the right eye image in one given frame; and a display data generator that generates display data used to display the left eye image and the right eye image alternately in time on the display module based on the left eye image display data and the right eye image display data.

In the above image display device, the average brightness controller may include: an image processor that generates left eye image display data and right eye image display data such that a number of pixels contributing to a display of the left eye image in one given frame is different from a number of pixels contributing to a display of the right eye image in the same frame; and a display data generator that generates display data used to display the left eye image and the right eye image alternately in time on the display module based on the left eye image display data and the right eye image display data.

In the above image display device, the average brightness controller may include a display data generator that generates display data used to display left eye image display data and right eye image display data separately in time on the display module such that a number of times a left eye image is displayed in one given frame is different from a number of times a right eye image is displayed in the same frame.

In the above image display device, the display module may include a backlight that illuminates a display screen, and the average brightness controller may include: an image processor that generates left eye image display data and right eye image display data such that a maximum brightness of the left eye image in one given frame is equal to a maximum brightness of the right eye image in the same frame; a display data generator that generates display data used to display the left eye image and the right eye image alternately in time on the display module based on the left eye image display data and the right eye image display data; and a backlight controller that regulates a brightness of the backlight such that a brightness of the backlight generated when the left eye image is displayed in one given frame is different from a brightness of the backlight generated when the right eye image is displayed in the same frame.

In the above image display device, it is preferable that the vision aid includes two shutters that can be opened and closed independently from each other, one at a left eye portion and the other at a right eye portion; and the image display device includes a shutter controller that outputs, to the vision aid, a shutter control signal for controlling opening and closing of the shutters, the shutter controller controlling the shutters such that an open time of one of the shutter of the left eye portion and the shutter of the right eye portion of the vision aid that corresponds to one of the left eye image and the right eye image that has a higher average brightness per frame is shorter than an open time of the other shutter. In this arrangement, the open time of the one shutter corresponding to the one of the left eye image and the right eye image that has a higher average brightness per frame is shorter than the open time of the other shutter to balance the persistences of vision in the left and right eyes of a viewer with a vision aid against each other. As a result, a viewer with a vision aid can view a naturally stereoscopic stereo image resulting from a balanced combination of a left eye image and a right eye image. Accordingly, this arrangement is advantageously capable of presenting a less strange image to both a viewer with and viewer without a vision aid when both of them are present.

In the above image display device, it is also preferable that the vision aid includes two shutters that can be opened and closed independently from each other and are each capable of controlling a light transmittance, one at a left eye portion and the other at the right eye portion; and the image display device includes a shutter controller that outputs, to the vision aid, a shutter control signal for controlling opening and closing of the shutters, the shutter controller controlling the shutters such that a light transmittance of one of the shutter of the left eye portion and the shutter of the right eye portion of the vision aid that corresponds to one of the left eye image and the right eye image that has a higher average brightness per frame is lower than a light transmittance of the other shutter. Again, this preferred arrangement balances the persistences of vision in the left and right eyes of a viewer with a vision aid against each other. Thus, a viewer with a vision aid can view a naturally stereoscopic stereo image resulting from a balanced combination of a left eye image and a right eye image. As a result, a less strange image can be advantageously presented to both a viewer with and viewer without a vision aid when both of them are present.

In the above image display device, the display module may include a first polarizing filter provided at a location that displays the left eye image and a second polarizing filter provided at a location that displays the right eye image and having a polarization property different from that of the first polarizing filter; and the vision aid may include, at the left eye portion, a left eye polarizing filter that passes light that has passed through the first polarizing filter and, at the right eye portion, a right eye polarizing filter that passes light that has passed through the second polarizing filter. The vision aid may further include a dark filter deposited on one of the left eye polarizing filter and the right eye polarizing filter of the vision aid that corresponds to one of the left eye image and the right eye image that has a higher average brightness per frame.

A stereo image display system according to an embodiment of the present invention is a stereo image display system including an image display device and a vision aid, the image display device including: a display module capable of displaying a left eye image to be viewed via a left eye portion of the vision aid and a right eye image to be viewed via a right eye portion of the vision aid, the left eye and right eye images being displayed separately in time and space; and an average brightness controller capable of regulating an average brightness of the left eye image and an average brightness of the right eye image displayed on the display module in one given frame such that these average brightnesses are different from each other, the vision aid including an image selector capable of allowing only the left eye image to pass through the left eye portion and allowing only the right eye image to pass through the right eye portion.

According to this arrangement, the average brightness controller of the image display device regulates the average brightness of a left eye image and the average brightness of a right eye image displayed on the display module in one given frame such that these average brightness are different from each other, thereby making one of the left eye and right eye images more visible than the other to a viewer without a vision aid. This mitigates the situation of the left eye and right eye images being visible as superimposed offset images. As a result, a stereo image display system is realized that allows a person viewing the screen without a vision aid to view a less strange image.

In the above stereo image display system, it is preferable that the image selector of the vision aid includes two shutters that can be opened and closed independently from each other, one at a left eye portion and the other at a right eye portion; the image display device includes a shutter controller that outputs, to the vision aid, a shutter control signal for controlling opening and closing of the shutters, the shutter controller controlling the shutters such that an open time of one of the shutter of the left eye portion and the shutter of the right eye portion of the vision aid that corresponds to one of the left eye image and the right eye image that has a higher average brightness per frame is shorter than an open time of the other shutter.

In this arrangement, the open time of each of the shutters is regulated in the above manner to balance the persistences of vision in the left and right eyes of a viewer with a vision aid against each other. As a result, a viewer with a vision aid can view a naturally stereoscopic stereo image resulting from a balanced combination of a left eye image and a right eye image. Accordingly, this arrangement is advantageously capable of presenting a less strange image to both a viewer with and viewer without a vision aid when both of them are present.

In the above stereo image display system, it is also preferable that the image selector of the vision aid includes two shutters that can be opened and closed independently from each other and are each capable of controlling a light transmittance, one at a left eye portion and the other at the right eye portion; and the image display device includes a shutter controller that outputs, to the vision aid, a shutter control signal for controlling opening and closing of the shutters, the shutter controller controlling the shutters such that a light transmittance of one of the shutter of the left eye portion and the shutter of the right eye portion of the vision aid that corresponds to one of the left eye image and the right eye image that has a higher average brightness per frame is lower than a light transmittance of the other shutter.

This arrangement also balances the persistences of vision in the left and right eyes of a viewer with a vision aid against each other. As a result, a viewer with a vision aid can view a naturally stereoscopic stereo image resulting from a balanced combination of a left eye image and a right eye image. Accordingly, this arrangement is advantageously capable of presenting a less strange image to both a viewer with and viewer without a vision aid when both of them are present.

A vision aid according to an embodiment of the present invention is a vision aid including two shutters that can be opened and closed independently from each other, one at a left eye portion and the other at a right eye portion, including an image selector capable of allowing only a left eye image to pass through the left eye portion and allowing only a right eye image to pass through the right eye portion, the left eye image and the right eye image being displayed, on a display module of an image display device, separately in time and space so as to have different average brightnesses in one given frame.

It is preferable that, in the above vision aid, the image selector includes two shutters that can be opened and closed independently from each other in response to a shutter control signal output from the image display device, one shutter being located at the left eye portion and the other shutter at the right eye portion, wherein an open time of one of the shutter of the left eye portion and the shutter of the right eye portion that corresponds to one of the left eye image and the right eye image that has a higher average brightness per frame is shorter than an open time of the other shutter. This arrangement balances the persistences of vision in the left and right eyes of a viewer with a vision aid against each other, allowing the viewer to view a naturally stereoscopic stereo image.

It is also preferable that, in the vision aid, the image selector includes two shutters that can be opened and closed independently from each other and are each capable of controlling a light transmittance in response to a shutter control signal output from the image display device, one shutter being located at the left eye portion and the other shutter at the right eye portion, wherein a light transmittance of one of the shutter of the left eye portion and the shutter of the right eye portion that corresponds to one of the left eye image and the right eye image that has a higher average brightness per frame is lower than a light transmittance of the other shutter. This arrangement also balances the persistences of vision in the left and right eyes of a viewer with a vision aid against each other, allowing the viewer to view a naturally stereoscopic stereo image.

Some of the more specific embodiments of the present invention will now be described with reference to the drawings. For ease of understanding, in the drawings referred to below, the configuration may be simplified or be shown schematically, or some components may be omitted. Further, the size ratio of the components shown in the drawings do not necessarily represent the actual size ratios.

### First Embodiment

The first embodiment of the present invention will be described below. FIG. 1 is a schematic view of an entire stereo image display system according to a first embodiment. As shown in FIG. 1, the stereo image display system according to the first embodiment includes an image display device 1 and a pair of shutter glasses, or a vision aid, 2.

In the present embodiment, the image display device 1 is a liquid crystal display. However, the image display device 1 is not limited to a liquid crystal display and may be any light emitting display or a non-light emitting display. Examples of light emitting displays include, but are not limited to, cathode ray tubes, plasma displays, organic electroluminescent devices, inorganic electroluminescent devices and field emission displays. Examples of non-light emitting displays include, but are not limited to, liquid crystal displays mentioned above as well as rear projection devices.

The image display device 1 includes a display module 11 for displaying images and a shutter controller 12 for transmitting shutter control signals to the shutter glasses 2. The display module 11 is constituted by a liquid crystal panel, and displays an image based on display data received from a video processor 13, described later.

The shutter glasses 2 include liquid crystal shutters 21L and 21R fitting into the left eye portion and right eye portion, respectively, of the frame 22. Further, the shutter glasses 2 include a control signal receiver 23 on the frame 22. It should be noted that, while the shutter glasses 2 shown in FIG. 1 are in the shape of glasses that can be mounted on the nose and ears, the vision aid is not limited to this configuration and can be modified in a variety of ways; for example, it can be in the shape of a goggle, a head-mounted device, opera glasses or the like. Furthermore, in the implementation of FIG. 1, the control signal receiver 23 is provided on the bridge of the frame. However, the control signal receiver 23 may be provided anywhere on the shutter glasses 2 where it can receive shutter control signals from the shutter controller 12 of the image display device 1.

Now, the configuration of the shutter glasses 2 will be described. FIG. 2 is a schematic cross-sectional view of the liquid crystal shutters 21L and 21R of the shutter glasses 2. It should be noted that FIG. 2 does not exactly represent the size ratio of the components. As shown in FIG. 2, each of the liquid crystal shutters 21L and 21R of the shutter glasses 2 includes a liquid crystal cell 211 as well as polarizers 212 and 213 provided on the front and back sides, respectively, of the liquid crystal cell 211. The liquid crystal cell 211 includes liquid crystal enclosed between a pair of electrode substrates 211a and 211b. A power supply, or a battery, 214 for applying voltage between the electrode substrates 211a and 211b is incorporated in the frame 22 of the shutter glasses 2, for example. A switch circuit 215 is provided to switch on and off voltage applied to the electrode substrates 211a and 211b from the power supply 214. The polarizers 212 and 213 are linear polarizers and are arranged in such a way that their polarizing axes are parallel to each other, for example.

Although an implementation is described in which the liquid crystal cell 211 uses TN (twisted nematic) liquid crystal, the liquid crystal cell 211 is not limited to this liquid crystal mode and may use any liquid crystal mode. For example, when the switch of the switch circuit 215 is open and no voltage is applied to the liquid crystal cell 211, linearly polarized light that has passed through the front polarizer 212 (i.e. the one which light from the image display device 1 enters) is rotated along the twist of liquid crystal molecules in the liquid crystal cell 211 while passing through the cell. Accordingly, in this case, no light that has passed through the liquid crystal cell 211 passes through the polarizer 213. Thus, when no voltage is applied to the liquid crystal cell 211, the liquid crystal shutters 21L and 21R work to block light from the image display device 1.

On the other hand, when the switch of the switch circuit 215 is closed and voltage is applied to the liquid crystal cell 211, liquid crystal molecules in the liquid crystal cell 211 move such that the long axes of the molecules are perpendicular to the substrate surface of the liquid crystal cell 211. Thus, light passes through the liquid crystal cell 211 without being affected by liquid crystal molecules in the liquid crystal cell 211, and then passes through the polarizer 213. Thus, when voltage is applied to the liquid crystal cell 211, the liquid crystal shutters 21L and 21R work to pass light from the image display device 1.

In response to a shutter control signal from the shutter controller 12 of the image display device 1, the switch circuit 215 of the shutter glasses 2 is switched on and off to separately turn on and off voltage applied to the liquid crystal cell 211 of each of the liquid crystal shutters 21L and 21R, thereby independently open and close each of the liquid crystal shutters 21L and 21R for light from the image display device. As such, in this implementation, each of the liquid crystal shutters 21L and 21R blocks light from the image display device 1 (i.e. “the shutter is closed”) as voltage applied to the liquid crystal cell 211 is turned off, and passes light from the image display device 1 (i.e. “the shutter is open”) as voltage applied is turned on.

Although in this implementation, the polarizers 212 and 213 have their polarizing axes parallel to each other, the polarizers 212 and 213 may have their polarizing axes perpendicular to each other. In this case, the relationships between on/off of voltage applied to the liquid crystal cell 211 and passing/blocking of light by the liquid crystal shutters 21L and 21R are reversed from those described above.

Further, if the image display device 1 is a liquid crystal display panel, the one of the polarizers 212 and 213 on the liquid crystal shutters 21L and 21R facing the image display device may be omitted and a polarizer may only be provided on the viewer's side of each of the liquid crystal shutters 21L and 21R.

Any communication method may be employed for the communication between the shutter controller 12 of the image display device 1 and the control signal receiver 23 of the shutter glasses 2. Although FIG. 1 illustrates the wireless communication between the shutter controller 12 and the control signal receiver 23, communication may be established via a cable, too. It should be noted that if wireless communication is to be employed, any wireless communication such as infrared communication or Bluetooth® may be used.

In the present embodiment, the display module 11 of the image display device 1 displays a left eye image and a right eye image alternately in time. A left eye image is an image to be viewed by the left eye of the viewer if the viewer looks at the displayed object. A right eye image is an image to be viewed by the right eye of the viewer if the viewer looks at the displayed object. More specifically, a left eye image and a right eye image have a parallax that creates the illusion of depth, which may otherwise be perceived when a three-dimensional object is viewed by both eyes, as the left eye image is only viewed by the left eye and the right eye image is only viewed by the right eye.

The shutter controller 12 transmits a shutter control signal for controlling opening and closing of each of the liquid crystal shutters 21L and 21R of the shutter glasses 2 in synchronization with a display of a left eye image or a right eye image on the display module 11. A shutter control signal controls the liquid crystal shutter 21L or 21R such that the right eye liquid crystal shutter 21R is closed while a left eye image is displayed on the display module 11 and the left eye liquid crystal shutter 21L is closed while a right eye image is displayed on the display module 11. How each of the liquid crystal shutters 21L and 21R is opened and closed in the present embodiment will be described later in more detail.

Thus, the stereo image display system allows a viewer to view a stereo image by displaying a left eye image and a right eye image alternately in time on the display module 11 of the image display device 1 and controlling opening and closing of each of the liquid crystal shutters 21L and 21R of the shutter glasses 2 in synchronization with such a display. That is, each of the liquid crystal shutters 21L and 21R is opened and closed such that the viewer only views left eye images with his left eye and only views right eye images with his right eye. Switching between left and right eye images at such high speed that a total of 60 images, for example, are displayed per second will allow the viewer to perceive a stereoscopic image as if the viewer were seeing an object with his both eyes as a result of persistence of vision in the human eyes.

As used herein, one frame represents a time period necessary to display the left eye and right eye images constituting one stereo image. For example, if 60 images are displayed in a second, as above, each of the alternately displayed left and right eye images is displayed for 16.7 milliseconds, and thus a period of 33.4 milliseconds corresponds to one frame. It should be noted that, in this implementation, one frame is made up of two subframes, one for displaying a left eye image and the other for displaying a right eye image. However, one frame is not limited to such a relationship, and at least one of a left eye image and a right eye image may contain several subframes. For example, one frame may be made up of four or more subframes, as described later in another embodiment (see, for example, FIG. 10).

Now, the functional configuration of the image display device 1 will be described with reference to FIG. 3. FIG. 3 is a block diagram of the functional configuration of the image display device 1. As shown in FIG. 3, the image display device 1 includes a video processor 13 that provides stereo image display functionality. The video processor 13 includes a parallax image generator 131, an image processor 132, a display data generator 133 and a timing controller 134. The image processor 132 includes a left eye image processor 132L and a right eye image processor 132R. In the present embodiment, the image processor 132 and the display data generator 133 function as an average brightness controller.

The parallax image generator 131 receives a video signal 50 and generates a left eye image and a right eye image from the received video signal 50. The generated left eye image is sent to the left eye image processor 132L of the image processor 132. The right eye image is sent to the right eye image processor 132R of the image processor 132.

A video signal 50 is transmitted from the outside in accordance with a format used to display stereo images. This transmission format is defined by an interface standard, such as HDMI (High-Definition Multimedia Interface). For example, HDMI 1.4 defines the following three transmission formats for video signals 50:

(1) a format for alternately transmitting a component of a left eye image and a component of a right eye image for each predetermined period of time or each predetermined line;

(2) a format for transmitting an image of one frame, in which a left eye image is disposed on the left half in the horizontal direction and a right eye image on the right half in the horizontal direction; and

(3) a format for transmitting a two-dimensional video signal together with distance information (for a distance in the depth direction).

The parallax image generator 131 extracts a left eye image and a right eye image from the video signal 50 in accordance with the transmission format for the video signal 50. For example, if the video signal 50 is transmitted in format (1) above, the parallax image generator 131 sorts image components into left eye imagery and right eye imagery, one for each frame or line or each field. If the video signal 50 complies with transmission format (2) above, the parallax image generator 131 cuts out the left half in the horizontal direction from an image of one frame to make a left eye image, and cuts out the right half to make a right eye image. If the video signal 50 complies with transmission format (3) above, the parallax image generator 131 generates a left eye image and a right eye image based on the distance information of the pixels.

The interface for the video signal 50 is not limited to HDMI and may be any other interface. The video signal 50 may be a pure two-dimensional video signal, in which case the parallax image generator 131 may add appropriate distance information to each pixel in accordance with a predetermined algorithm to generate a left eye image and a right eye image from the video signal 50.

In the image processor 132, the left eye image processor 132L and the right eye image processor 132R generate left eye image display data and right eye image display data, respectively, based on the left eye image and the right eye image, respectively, from the parallax image generator 131 as well as brightness ratio data 60 and mode switching data 61, and forwards the data to the display data generator 133. What processes are performed at the image processor 132 will be described later in detail.

The display data generator 133 arranges left eye image display data and right eye image display data from the image processor 132 in an alternating manner to generate display data to be displayed on the display module 11 and forwards it to the timing controller 134. In response to a timing signal, such as a vertical synchronization signal, the timing controller 134 sends the display data to the display module 11 such that it alternately displays a left eye image and a right eye image, one at a time (i.e. one image per subframe). Thus, in the present embodiment, one left eye image and one right eye image are displayed in one frame. The timing controller 134 sends a synchronization signal to the shutter controller 12 in synchronization with a display of left eye image display data or right eye image display data on the display module 11.

In response to the synchronization signal, the shutter controller 12 transmits a shutter control signal for controlling opening and closing of each of the liquid crystal shutters 21L and 21R of the shutter glasses 20. The control signal may be a signal of any waveform that enables synchronizing with a switch of display between a left eye image and a right eye image on the display module 11 and enables determining whether a left eye image or a right eye image is to be displayed.

Now, how the image processor 132 works to generate left eye image display data and right eye image display data based on a left eye image and a right eye image, respectively, from the parallax image generator 131 as well as brightness ratio data 60 and mode switching data 61 will be described in more detail.

Mode switching data 61 is a parameter that determines a display mode on the display module 11. In a stereo image display system according to the present embodiment, the viewer can choose a preferred mode from at least the two modes for stereo image display: (a) the mode that displays images only suitable for viewing with shutter glasses (hereinafter referred to as the “3D-only mode”); and (b) the mode that is suitable when both a viewer with shutter glasses and a viewer without them are present (hereinafter referred to as the “2D/3D dual purpose mode”). In addition to the 3D-only mode and the 2D/3D dual purpose mode, a mode that only performs two-dimensional display (hereinafter referred to as the “2D-only mode”) may be selectable. The mode to be chosen may be input via an appropriate button or the like provided on the image display device 1, for example. It is also preferable that the viewer can select a mode using a remote control or the like on a setting screen displayed on the screen of the image display device 1. The selected mode is input to the image processor 132 in the form of mode switching data 61.

FIG. 4 illustrates the timing of images displayed on the display module 11 of the image display device 1 and the timing of the opening and closing of the liquid crystal shutters 21L and 21R of the shutter glasses 2 performed when the 3D-only mode is selected. FIG. 5 illustrates the timing of images displayed on the display module 11 of the image display device 1 and the timing of the opening and closing of the liquid crystal shutters 21L and 21R of the shutter glasses 2 performed when the 2D/3D dual purpose mode is selected.

When the 3D-only mode is selected, the image processor 132 generates left eye image display data and right eye image display data such that the maximum brightness of a left eye image displayed on the display module 11 is the same as that of a right eye image, as shown in FIG. 4. In the top section of FIG. 4, portions labeled with the character “L” indicate the brightness of left eye images, while those with the character “R” indicate the brightness of right eye images. When the 2D/3D dual purpose mode is selected, the image processor 132 generates left eye image display data and right eye image display data such that the maximum brightness of a left eye image, L_{left}, to be displayed on the display module 11 in one given frame is higher than the maximum brightness of a right eye image, L_{right}, in the same frame, as shown in FIG. 5. In other words, in the 2D/3D dual purpose mode of the present embodiment, left eye image display data and right eye image display data are generated such that the average brightness of a left eye image to be displayed on the display module 11 in one given frame is higher than the average brightness of a right eye image in the same frame. Average brightness means the amount of light emitted per unit area of the display, or display module 11.

The maximum brightness of a left eye image L_{left} is the brightness of a pixel generated when the highest tone level (i.e. the brightest tone level) that can be covered by a pixel in the left eye image is displayed on the display module 11. Similarly, the maximum brightness of a right eye image L_{right} is the brightness of a pixel generated when the highest tone level (i.e. the brightest tone level) that can be covered by a pixel in the right eye image is displayed on the display module 11.

The brightness ratio data 60 represents the ratio of the maximum brightness of a right eye image L_{right} relative to the maximum brightness of a left eye image L_{left}. That is, if the value of the brightness ratio data 60 is represented by α,

α=L_{right}/L_{left}.

The right eye image processor 132R generates right eye image display data (i.e. the tone of each of the pixels constituting the right eye image) by multiplying the tone level number of each of the pixels of the right eye image received from the parallax image generator 131 by α. Thus, if the value of α is 0.5, for example, supposing the original image has 256 tone levels, the right eye image display data is generated such that the maximum tone level of the right eye image display data is 128.

Thus, in the 2D/3D dual purpose mode, right eye image display data is generated such that the maximum brightness of a left eye image L_{left} to be displayed on the display module 11 is higher than the maximum brightness of a right eye image L_{right}. This results in a stronger persistence of vision of a left eye image than that of a right eye image to a viewer looking at an image displayed on the display module 11 without shutter glasses. As a result, the undesirable situation of right eye and left eye images being visible as superimposed offset images to a viewer without shutter glasses is mitigated. It should be noted that as the difference between the maximum brightness of a left eye image L_{left} and the maximum brightness of a right eye image L_{right} increases, the left eye image becomes more visible and the right eye image becomes less visible to a viewer without shutter glasses such that the viewer can view an image displayed on the display module 11 with less strangeness.

When the viewer looks at the image display device 1 of the present embodiment with shutter glasses 2, the right eye liquid crystal shutter 21R is closed while a left eye image is displayed on the display module 11 such that the left eye image is not visible to the right eye of the viewer, as shown in FIGS. 4 and 5. Further, the left eye liquid crystal shutter 21L is closed while a right eye image is displayed on the display module 11. Furthermore, as can be understood from a comparison between FIGS. 4 and 5, in the 3D-only mode (FIG. 4), the left eye liquid crystal shutter 21L is open during a period that is substantially the same as the period during which a left eye image is displayed on the display module 11, while in the 2D/3D dual purpose mode (FIG. 5), the left eye liquid crystal shutter 21L is open only during a portion of the period during which a left eye image is displayed on the display module 11 (T_{left}). This is done in order to balance the persistences of vision in the left and right eyes of a viewer with shutter glasses 2 against each other by making the period during which the left eye liquid crystal shutter 21L is open shorter than the period during which the right eye liquid crystal shutter 21R is open, since the brightness of left eye images are higher than the brightness of right eye images. As a result, the viewer with shutter glasses 2 can view a naturally stereoscopic stereo image resulting from a balanced combination of a left eye image and a right eye image. Accordingly, controlling the timing of the opening and closing of the liquid crystal shutters 21L and 21R of the shutter glasses 2 as shown in FIG. 5 advantageously enables presenting a less strange image to both a viewer with and viewer without shutter glasses 2 when both of them are present.

Preferably, the ratio of the length of the period during which the left eye liquid crystal shutter 21L is open (T_{left} of FIG. 5) to the length of the period during which the right eye liquid crystal shutter 21R is open (T_{right} of FIG. 5) is dependent on the ratio of the maximum brightness of a right eye image L_{right} to the maximum brightness of a left eye image L_{left} (the value of α above). To balance the persistences of vision in the left and right eyes of a viewer against each other, it is preferable that the length of the period during which the left eye liquid crystal shutter 21L is open T_{left} decreases as the value of a becomes smaller. For example, in one preferred implementation, the values of T_{left} and T_{right} are determined so as to satisfy:

α=L_{right}/L_{left}=T_{left}/T_{right}.

The shutter controller 12 generates a shutter control signal for controlling opening and closing of the liquid crystal shutters 21L and 21R based on the values of T_{left} and T_{right}.

For example, if a total of 60 alternating left and right eye images are displayed per second and α=0.5, then preferably T_{left}=0.835 milliseconds and T_{right}=1.67 milliseconds.

As described above, in a stereo image display system according to the first embodiment, an operation mode (2D/3D dual purpose mode) that makes the maximum brightness of a left eye image L_{left} larger than the maximum brightness of a right eye image L_{right} can be selected. Thus, if a viewer without shutter glasses 2 is present, this mode may be selected to mitigate the undesirable situation of right eye and left eye images being visible as superimposed offset images to the viewer without shutter glasses 2.

Further, in a stereo image display system according to the first embodiment, in the 2D/3D dual purpose mode, the period during which the left eye liquid crystal shutter 21L is open is preferably shorter than the period during which the right eye liquid crystal shutter 21R is open. This preferred implementation balances the persistences of vision in the left and right eyes of a viewer with shutter glasses 2 against each other. Thus, this implementation advantageously allows a viewer without shutter glasses 2 to view a two-dimensional image where offsets are less visible, and at the same time allows a viewer with shutter glasses 2 to view a natural stereo image resulting from a balanced combination of a left eye image and a right eye image.

In the above description, the tone level of each of the pixels of a left eye image received from the parallax image generator 131 is not altered and only a right eye image received from the parallax image generator 131 is modified by multiplying the tone level number of each pixel by a to make the maximum brightness of the right eye image smaller than the maximum brightness of the left eye image. Alternatively, the image processor 132 may multiply a parameter about each of a left eye image and a right eye image by a predetermined coefficient to generate left eye image display data and right eye image display data. For example, the left eye image processor 132L may multiply the tone level number of each of the pixels of a left eye image received from the parallax image generator 131 by the coefficient β1 to generate left eye image display data, while the right eye image processor 132R may multiply the tone level number of each of the pixels of a right eye image received from the parallax image generator 131 by the coefficient β2 to generate right eye image display data, where 0<β2<β1<=1. For example, good results can be achieved if β1=0.75 and β2=0.25, although this set of values is merely an example.

### Second Embodiment

A second embodiment of the present invention will be described below. The components with the similar functions as those of the above embodiment are labeled with the same reference characters as in the above embodiment and their detailed description will be omitted. This applies to the other embodiments below.

In the first embodiment, the shutter glasses 2 provided light blocking and light passing by controlling the liquid crystal shutters 21L and 21R such that each of the shutters is either completely open or completely closed. In contrast, in the second embodiment, the 2D/3D dual purpose mode sets a voltage applied to the liquid crystal cell 211 such that it passes only a portion, not all, of the light that has passed through the polarizer 212 to the polarizer 213 when the liquid crystal cell 211 of the liquid crystal shutter 21L is open. Specifically, supposing the voltage applied when the liquid crystal shutter 21L passes no light is 0 volts and the voltage applied when the amount of light passing through the liquid crystal shutter 21L is at its most is Vₘₐₓ, the amount of light passing through the liquid crystal shutter 21L varies in accordance with the value of the voltage applied if the voltage applied is a value between 0 volts and Vₘₐₓ. Thus, the amount of light passing through the liquid crystal shutter 21L can be controlled by configuring the switch circuit 215 such that the voltage applied to the liquid crystal cell 211 is an appropriate value between 0 volts and Vₘₐₓ. The operations of the liquid crystal shutter 21R are the same as in the first embodiment.

The functional arrangement of an image display device 1 of the stereo image display system according to the second embodiment is similar to that shown in FIG. 3 in connection with the first embodiment. In the image display device 1 of the present embodiment, too, in the 2D/3D dual purpose mode, the image processor 132 generates left eye image display data and right eye image display data such that the maximum brightness of a left eye image Left is larger than the maximum brightness of a right eye image L_{right}. The method of generating display data is as described in connection with the first embodiment. The display data generator 133 arranges the generated left eye image display data and the right eye image display data in an alternating manner in time to generate display data to be displayed on the display module 11, and forwards it to the timing controller 134. In response to a timing signal, such as a vertical synchronization signal, the timing controller 134 forwards the display data to the display module 11 such that it displays one image at a time. Thus, the present embodiment also alternately displays one image from left eye image display data and one image from right eye image display data during a subframe. Thus, two subframes make up one frame. The timing controller 134 sends a synchronization signal to the shutter controller 12 in synchronization with a display of the left eye image display data or right eye image display data on the display module 11.

Thus, the display module 11 of the image display device 1 of the present embodiment alternately displays a left eye image and a right eye image that has a lower maximum brightness than that of the left eye image, on a subframe basis. This results in a persistence of vision of a left eye image that is stronger than that of a right eye image for a viewer viewing images on the display module 11 without shutter glasses, such that the offsets of a left eye image and a right eye image are less visible to the viewer. As a result, the feeling of strangeness experienced by the viewer seeing stereoscopic display images on the display module 11 without shutter glasses is mitigated.

Based on a synchronization signal from the timing controller 134, the shutter controller 12 causes the left eye liquid crystal shutter 21L to be opened and causes the right eye liquid crystal shutter 21R to be closed when a left eye image is displayed on the display module 11. The shutter controller 12 causes the right eye liquid crystal shutter 21R to be opened and causes the left eye liquid crystal shutter 21L to be closed when a right eye image is displayed on the display module 11. Thus, the viewer with shutter glasses 2 only views left eye images with his left eye and only views right eye images with his right eye. Further, the amount of light passing through the liquid crystal shutter 21L of the shutter glasses 2 when it is open is smaller than the amount of light passing through the liquid crystal shutter 21R when it is open. Thus, the amount of light from a left eye image entering the left eye of the viewer with shutter glasses 2 is reduced so as to be smaller than the amount of light from a right eye image entering the right eye. Preferably, the ratio of the amount of light passing through the liquid crystal shutter 21L when it is open relative to the amount of light passing through the liquid crystal shutter 21R when it is open is the reciprocal of the brightness ratio α. For example, if a total of 60 alternating left and right eye images are displayed per second and α=0.5, it is preferable that the transmittance of the liquid crystal shutter 21L is 0.5, where the transmittance of the liquid crystal shutter 21R when it is open is 1. Thus, the amount of light from a left eye image entering the left eye of the viewer is balanced against the amount of light from a right eye image entering the right eye. Thus, a viewer can view a natural stereo image where left and right eye images are balanced against each other.

In the second embodiment, the shutter controller 12 generates shutter control signals such that the length of a period during which the left eye liquid crystal shutter 21L is open (T_{left}) is equal to the length of a period during which the right eye liquid crystal shutter 21R is open (T_{right}), as shown in FIG. 6. That is, in this embodiment, controlling the amount of light passing through the liquid crystal shutter 21L of the shutter glasses 2 balances the brightnesses of left eye and right eye images against each other when viewed stereoscopically. Accordingly, the liquid crystal shutters 21R and 21L may be open for an equal time.

Thus, a stereo image display system according to the second embodiment makes the maximum brightness of a left eye image L_{left} larger than the maximum brightness of a right eye image L_{right} to mitigate the undesirable situation of right eye and left eye images being visible as superimposed offset images to a viewer without signal glasses. Further, reducing the amount of light passing through the left eye liquid crystal shutter 21L of the shutter glasses 2 when it is open balances the persistences of vision in the left and right eyes of a viewer with shutter glasses 2 against each other. Thus, a viewer with shutter glasses 2 can view a natural stereo image resulting from a balanced combination of a left eye image and a right eye image. Accordingly, a stereo image display system of the present embodiment is advantageously capable of presenting a less strange image to both a viewer with and viewer without shutter glasses when both of them are present.

### Third Embodiment

A third embodiment of the present embodiment will be described below. An image display device 1 according to the third embodiment alternately displays a left eye image and a right eye image with an equal maximum brightness, but generates left eye image display data and right eye image display data such that the number of pixels contributing to the display of a right eye image is smaller than the number of pixels contributing to the display of a left eye image when the 2D/3D dual purpose mode is selected. Thus, in the image display device 1 according to the third embodiment, the image processor 132 in the video processor 13 described in connection with the first embodiment is replaced by an image processor 135 that performs different processes, as shown in FIG. 7. In the present embodiment, the image processor 135 and the display data generator 133 function as an average brightness controller.

The image processor 135 receives mode switching data 61 and pixel mapping pattern data 62. The pixel processor 135 includes a left eye image processor 135L and a right eye image processor 135R. When the 3D-only mode is selected, the left eye image processor 135L generates left eye image display data where all the pixels in one screen are active. When the 2D/3D dual purpose mode is selected, the left eye image processor 135L generates left eye image display data where only some of the pixels in one screen are active, based on pixel mapping pattern data 62. When the 3D-only mode is selected, the right eye image processor 135R generates right eye image display data where all the pixels in one screen are active. When 2D/3D dual purpose mode is selected, the right eye image processor 135R generates right eye image display data where only some of the pixels in one screen, fewer than those of a left eye image, are active, based on pixel mapping pattern data 62.

Pixel mapping pattern data 62 represents the spatial distribution of the pixels contributing to the display of a left eye image and the pixels contributing to the display of a right eye image on the display module 11. FIG. 8 schematically illustrates the distribution of pixels represented by pixel mapping pattern data 62. In FIG. 8, the rectangles labeled with the character “L” correspond to pixels displaying a left eye image, while the rectangles labeled with the character “R” correspond to pixels displaying a right eye image.

In the example shown in FIG. 8, a total of four pixels, i.e. two in the vertical direction multiplied by two in the horizontal direction, make up one unit, of which three pixels contribute to the display of a left eye image, while the remaining one pixel contributes to the display of a right eye image. However, the number of pixels constituting one unit, and the ratio of the number of pixels contributing to the display of a right eye image relative to the number of pixels contributing to the display of a left eye image as well as the arrangement thereof are not limited to the example of FIG. 8 and may be modified as desired.

The left eye image processor 135L of the image processor 135 extracts the tone data of the pixels contributing to the display of a left eye image from a left eye image received from the parallax image generator 131 based on the pixel mapping pattern data 62, and sets those pixels that contribute to the display of a right eye image to zero (corresponding to the display of black) as tone data to generate left eye image display data, and outputs it to the display data generator 133. The right eye image processor 135R of the image processor 135 extracts the tone data of the pixels contributing to the display of a right eye image from a right eye image received from the parallax image generator 131 based on the pixel mapping pattern data 62, and sets those pixels that contribute to the display of a left eye image to zero (corresponding to the display of black) as tone data to generate right eye image display data, and outputs it to the display data generator 133. Accordingly, in left eye image display data, three fourths of all the pixels contribute to the display of a left eye image as active pixels, while the remaining one fourth of the pixels display black. On the contrary, in right eye image display data, one fourths of all the pixels contribute to the display of a right eye image as active pixels, while the remaining three fourths of the pixels display black.

The display data generator 133 arranges, in an alternating manner, left eye image display data and right eye image display data received from the image processor 135 on a subframe basis to generate display data to be displayed on the display module 11 and forwards it to the timing controller 134. In response to a timing signal, such as a vertical synchronization signal, the timing controller 134 forwards the display data to the display module 11 such that it displays it on a frame basis. The timing controller 134 sends a synchronization signal to the shutter controller 12 in synchronization with a display of left eye image display data or right eye image display data on the display module 11.

Thus, the present embodiment alternately displays, on a subframe basis, a left eye image where three fourths of all the pixels contribute to a display as active pixels and a right eye image where one fourth of all the pixels contribute to a display as active pixels. This results in a stronger persistence of vision of a left eye image than that of a right eye image in the corresponding eyes of a viewer looking at an image displayed on the display module 11 without shutter glasses. Thus, the undesirable situation of right eye and left eye images being visible as superimposed offset images to a viewer without shutter glasses is mitigated.

The greater the difference is between the number of pixels contributing to the display of a left eye image and the number of pixels contributing to the display of a right eye image, the more visible the left eye image becomes and the less visible the right eye image becomes to a viewer without shutter glasses. This allows an image displayed on the display module 11 to be viewed with less offsets.

While the present embodiment has illustrated a pixel mapping pattern where no pixel can contribute to the display of both a left eye image and a right eye image, as shown in FIG. 8, at least some of the pixels may be capable of contributing to the display of both a left eye image and a right eye image. For example, in one preferred embodiment, all the pixels may be active when a left eye image is displayed, and some pixels may display black and thus may not contribute to a display when a right eye image is displayed.

In the present embodiment, it is preferable that the period during which the left eye liquid crystal shutter 21L is open is shorter than the period during which the right eye liquid crystal shutter 21R is open, similar to the implementation shown in the middle and bottom sections of FIG. 5. This balances the persistences of vision in the left and right eyes of a viewer with shutter glasses 2 against each other.

Alternatively, it is also preferable that the amount of light passing through the liquid crystal shutter 21L when it is open is reduced, as illustrated in connection with the second embodiment. This arrangement also balances the persistences of vision in the left and right eyes of a viewer with shutter glasses 2 against each other.

### Fourth Embodiment

A fourth embodiment of the present embodiment will be described below. An image display device 1 according to the fourth embodiment displays a left eye image and a right eye image having an equal maximum brightness, but is characterized in that the frequency of subframes displaying a left eye image in one frame is higher than that of subframes displaying a right eye image. Accordingly, in the image display device 1 according to the fourth embodiment, the image processor 132 and the display data generator 133 in the video processor 13 illustrated in connection with the first embodiment are replaced by an image processor 136 and a display data generator 137 that perform different processes, as shown in FIG. 9. In the present embodiment, the display data generator 137 functions as an average brightness controller.

The display data generator 137 receives mode switching data 61 and sequence pattern data 63. Sequence pattern data 63 represents a time-series pattern of a frame that displays one or more left eye images and one or more right eye images. Sequence pattern data 63 may represent a time-series pattern of a frame using a symbol representing a subframe of a left eye image (L in the following example) and a symbol representing a subframe of a right eye image (R in the following example), such as in L, L, L, R, L, L, L, R, . . . While this example uses L and R, for convenience, as symbols representing a subframe of a left eye image and a subframe of a right eye image, respectively, it would be simpler to use bits such as 0 and 1.

The image processor 136 generates left eye image display data and right eye image display data having an equal maximum brightness based on a left eye image and a right eye image received from the parallax image generator 131, and outputs it to the display data generator 137.

The display data generator 137 refers to the sequence pattern data 63 and arranges in time-sequence the left eye image display data and the right eye image display data in accordance with the pattern defined by the sequence pattern data 63. For example, if the sequence pattern data 63 is represented by L, L, L, R, L, L, L, R, as above, the left eye image display data and the right eye image display data are arranged in time-sequence such that only left eye images are displayed during the first to third subframes of one given frame and only a right eye image is displayed during the fourth subframe, as shown in FIG. 10. When this display data is displayed on the display module 11, the persistence of vision of the left eye images is stronger than that of the right eye image in a viewer without shutter glasses, thereby mitigating the undesirable situation of the left eye and right eye images being visible as superimposed offset images.

In the present embodiment, if the viewer is using shutter glasses 2, it is preferable that the shutter controller 12 generates shutter control signals that cause the left eye liquid crystal shutter 21L to be opened only during the second subframe and cause the right eye liquid crystal shutter 21R to be opened only during the fourth subframe, as shown in the middle and bottom sections of FIG. 10. Such shutter control balances the persistences of vision in the left and right eyes of a viewer with shutter glasses 2 against each other. Thus, a viewer with shutter glasses 2 can view a natural stereo image resulting from a balanced combination of a left eye image and a right eye image. Thus, a stereo image display system of the present embodiment is advantageously capable of presenting a less strange image to both a viewer with and viewer without shutter glasses when both of them are present.

Although in the example of FIG. 10 the left eye liquid crystal shutter 21L is open only during the second subframe, the left eye liquid crystal shutter 21L may be open only during the first subframe or the third subframe. However, an implementation where the shutter is open during the second subframe provides the advantage of less flicker being perceived since it means equal distances between periods when the left eye liquid crystal shutter 21L is open and periods when the right eye liquid crystal shutter 21R is open.

Alternatively, it is also preferable to reduce the amount of light passing through the left eye liquid crystal shutter 21L when it is open, as illustrated in connection with the second embodiment. This arrangement also balances the persistences of vision in the left and right eyes of a viewer with shutter glasses 2 against each other.

The frequencies of displays of left eye images and right eye images in time-series is not limited to 3:1, as above. Further, the order of displays of left eye images and right eye images is not limited to the above example.

While the above description of the present embodiment has illustrated an implementation where only one of a left eye image and a right eye image is displayed during one subframe, one frame of 16.7 milliseconds may be divided into four subframes and the following modification may be provided: one frame (for example, 16.7 milliseconds) may be divided into four subframes, for example, and the display device may be driven at the frequency of four times that of the above implementation (i.e. at 240 Hz), where only left eye images may be displayed during three subframes (for example, the first to third subframes) and only a right eye image may be displayed during the remaining one subframe (for example, the fourth subframe). This modification provides a stereo image with still less flicker.

### Fifth Embodiment

A fifth embodiment of the present invention will be described below. In an image display device according to the fifth embodiment, the display module 11 is replaced by a display module 51 shown in FIG. 11. FIG. 11 is an exploded perspective view of the display module 51. As shown in FIG. 11, the display module 51 includes a liquid crystal display panel 59 and a backlight unit 49 for illuminating the panel.

The display module 51 includes an active matrix substrate 51 and a counter substrate 52. These substrates enclose liquid crystal (not shown) therebetween and are set in a frame-shaped bezel (BZ). The active matrix substrate 51 and the counter substrate 52 are sandwiched by a pair of polarizers 53.

The backlight unit 49 includes an LED module MJ, a backlight chassis 41, a diffusing sheet 44, and prism sheets 45 and 46. The LED module MJ includes a mounting substrate 72 and LEDs 71. The mounting substrate 72 may be rectangular, for example, and has a plurality of electrodes (not shown) arranged regularly on a mounting surface 72U. The LEDs 71 are attached to these electrodes and supplied with electric power. The emission brightness of the LEDs 71 can be controlled via the value of current supplied by the electrodes.

FIG. 12 is a block diagram schematically illustrating the image display device according to the present embodiment. As shown in FIG. 12, the liquid crystal display device according to the present embodiment includes an image processor 139. The image processor 139 includes a left eye image processor 139L and a right eye image processor 139R. The left eye image processor 139L and the right eye image processor 139R generate left eye image display data and right eye image display data, respectively, with an equal maximum brightness. A display data generator 133 arranges the generated left eye image display data and right eye image display data in an alternating manner in time to generate display data. In the present embodiment, the image processor 139, the display data generator 133 and the backlight controller 55 function as an average brightness controller.

In the present embodiment, current supplied to the LEDs 71 is controlled such that in the 3D-only mode the backlight unit 49 emits the same amount of light during different subframes, while in the 2D/3D dual purpose mode the emission brightness of the backlight unit during a subframe for displaying a left eye image is higher than the emission brightness of the backlight during a subframe for displaying a right eye image. That is, as shown in FIG. 12, the display module 51 further includes a backlight controller 55 (not shown in FIG. 11) for controlling the backlight unit 49. The backlight controller 55 receives brightness ratio data 60 and, in accordance with the brightness ratio in this data in the 2D/3D dual purpose mode, controls current supplied to the LEDs 71 such that the emission brightness of the backlight during a subframe for displaying a left eye image is higher than the emission brightness of the backlight during a subframe for displaying a right eye image.

Changes in brightness of the backlight during each subframe in the present embodiment are as shown in FIGS. 4 and 5. This results in a stronger persistence of vision of a left eye image than that of a right eye image to a viewer looking at an image displayed on the display module 11 without shutter glasses, as in the first embodiment. Thus, the undesirable situation of right eye and left eye images being visible as superimposed offset images to a viewer without shutter glasses is mitigated.

Further, in the present embodiment, it is preferable that the period during which the left eye liquid crystal shutter 21L is open is shorter than the period during which the right eye liquid crystal shutter 21R is open, as shown in the middle and bottom sections of FIG. 5. This balances the persistences of vision in the left and right eyes of a viewer with shutter glasses 2 against each other.

Alternatively, it is also preferable to reduce the amount of light passing through the liquid crystal shutter 21L when it is open, as illustrated in connection with the second embodiment. This arrangement also balances the persistences of vision in the left and right eyes of a viewer with shutter glasses 2 against each other.

### Sixth Embodiment

A sixth embodiment of the present invention will be described below. FIG. 13 is a schematic view of an entire stereo image display system according to a sixth embodiment. As shown in FIG. 13, a stereo image display system according to the present embodiment performs stereoscopic display using an image display device 1 and polarized glasses 4.

The image display device 1 of the present embodiment includes a polarizing filter layer 16 on the surface of the display module 11. The polarizing filter layer 16 may include, for example, polarizing filters with two different polarization directions arranged in an alternating manner, one filter at each line (scan line) of the display module 11. The polarizing filters may be linearly polarizing filters or circularly polarizing filters.

For example, as shown in FIG. 14, linearly polarizing filters 16L are disposed at odd-numbered lines of the display module 11 such that the polarizing axes of the filters are parallel to these lines, and linearly polarizing filters 16R are disposed at even-numbered lines such that the polarizing axes of the filters are perpendicular to these lines. The display module 11 displays a left eye image on the odd-numbered lines, and displays a right eye image on the even-numbered lines. A linearly polarizing filter 41L is disposed on the left eye portion of the polarized glasses 4 such that its polarizing axis is identical with those of the linearly polarizing filters 16L, and a linearly polarizing filter 41R is disposed on the right eye portion of the glasses such that its polarizing axis is identical with those of the linearly polarizing filters 16R. This arrangement allows the left eye of a viewer with polarized glasses 4 to view only left eye images displayed on the odd-numbered lines and allows the right eye of the viewer to view only right eye images displayed on the even-numbered lines. This allows the viewer to view a stereo image with depth. Although in this implementation, the polarizing filters with two different polarization directions are arranged in an alternating manner, one filter for a line, polarizing filters with two different polarization directions may be arranged in an alternating manner such that one filter is provided for one or more pixels, and the display of a left eye image and a right eye image may be controlled on a pixel basis.

FIG. 15 is a block diagram schematically illustrating the functional configuration of the image display device 1 according to the present embodiment. As shown in FIG. 15, the image display device 1 according to the present embodiment includes a video processor 13 including a parallax image generator 131, an image processor 141, a display data generator 142 and a timing controller 134. In the present embodiment, the image processor 141 and the display data generator 142 function as an average brightness controller.

The image processor 141 receives a left eye image and a right eye image from the parallax image generator 131 and refers to brightness ratio data 60 to generate left eye image display data and right eye image display data. The display data generator 142 receives the left eye image display data and the right eye image display data from the image processor 141, inserts each left eye image display data element into the corresponding odd-numbered line and each right eye image display data element into the corresponding even-numbered line to generate one frame of data to be displayed, and forwards it to the timing controller 134. In response to a timing signal, such as a vertical synchronization signal, the timing controller 134 forwards the display data to the display module 11 such that it displays it, one frame at a time.

The image processor 141 refers to brightness ratio data 60 and generates left eye image display data and right eye image display data such that the maximum brightness of a left eye image L_{left} displayed on the display module 11 is higher than the maximum brightness of a right eye image L_{right}. The method of generating display data such that the maximum brightness of a left eye image L_{left} is higher than the maximum brightness of a right eye image L_{right} was described in connection with the first embodiment and thus their description will not be repeated.

Thus, as right eye image display data is generated such that the maximum brightness of a left eye image L_{left} displayed on the display module 11 is higher than the maximum brightness of a right eye image L_{right}, there is a stronger persistence of vision of the left eye image, on the odd-numbered lines, than that of the right eye image, on the even-numbered lines, in the eyes of a viewer looking at an image displayed on the display module 11 without polarized glasses 4. As a result, the undesirable situation of right eye and left eye images being visible as superimposed offset images to a viewer without polarized glasses 4 is mitigated. It should be noted that as the difference between the maximum brightness of a left eye image L_{left} and the maximum brightness of a right eye image L_{right} increases, the left eye image becomes more visible and the right eye image becomes less visible to a viewer without polarized glasses 4 such that the viewer can view the image displayed on the display module 11 with less strangeness.

If a viewer with polarized glasses 4 views the display module 11, the viewer only sees left eye images with his left eye and only sees right eye images with his right eye, such that he can perceive stereo images with depth.

Preferably, a dark filter 42 is deposited on the left eye linearly polarizing filter 41L of the polarized glasses 4. Preferably, the transmittance of the dark filter 42 is such that the maximum brightness of a left eye image that has passed through the filter is substantially equal to the maximum brightness of a right eye image. Thus, the brightness of a left eye image is substantially equal to that of a right eye image when the viewer sees a stereo display image through the polarized glasses 4, thereby allowing the viewer to view a stereo image in which the left eye image and the right eye image are balanced against each other.

Although embodiments of the present invention have been illustrated, these embodiments are mere examples for carrying out the present invention. Thus, the present invention is not limited to the embodiments above, and the embodiments above may be modified as desired without departing from the spirit of the invention.

For example, the embodiments above have illustrated implementations where left eye images are mainly viewed by a viewer without a vision aid. However, in a reversed configuration, right eye images may be mainly viewed by a viewer without a vision aid with similar results.

Further, the embodiments above have illustrated implementations where the parallax image generator 131 generates a left eye image and a right eye image from input video signal. However, an external device may separate a left eye image and a right eye image from each other in advance, which may then be input separately.

Furthermore, the first and other embodiments illustrated an implementation where a mode can be selected from the 3D-only mode and the 2D/3D dual purpose mode; however, the ability to select a mode is not a requirement for carrying out the present invention. For example, it is possible to provide a system that operates only in a mode referred to as the 2D/3D dual purpose mode in the above description.

### Additional Arrangements

In addition to the above embodiments, the following arrangements may be implemented.

### Additional Arrangement 1

An aspect of the present invention is an image display device that displays a left eye image and a right eye image, allows a left eye of a viewer with a vision aid to view a left eye image and allows a right eye of the viewer to view a right eye image to allow the viewer to view a stereoscopic image, the image display device including a video processor that processes at least one of the left eye image and the right eye image to make persistences of vision of the left eye image and the right eye image to a viewer without the vision aid different from each other.

### Additional Arrangement 2

Another aspect of the present invention is a stereo image display system that includes an image display device and a vision aid, displays a left eye image and a right eye image on the image display device, allows a left eye of a viewer with the vision aid to view a left eye image and allows a right eye of the viewer to view a right eye image to allow the viewer to view a stereoscopic image, the stereo image display system including a video processor that processes at least one of the left eye image and the right eye image to make persistences of vision of the left eye image and the right eye image to a viewer without the vision aid different from each other.

1. An image display device comprising:
a display module capable of displaying a left eye image to be viewed via a left eye portion of a vision aid and a right eye image to be viewed via a right eye portion of the vision aid, the left eye and right eye images being displayed separately in time and space; and
an average brightness controller capable of regulating an average brightness of the left eye image and an average brightness of the right eye image displayed on the display module in one given frame such that these average brightnesses are different from each other.

2. The image display device according to claim 1, wherein:
the average brightness controller includes:
an image processor that generates left eye image display data and right eye image display data such that a maximum brightness of the left eye image is different from a maximum brightness of the right eye image in one given frame; and
a display data generator that generates display data used to display the left eye image and the right eye image alternately in time on the display module based on the left eye image display data and the right eye image display data.

3. The image display device according to claim 1, wherein:
the average brightness controller includes:
an image processor that generates left eye image display data and right eye image display data such that a number of pixels contributing to a display of the left eye image in one given frame is different from a number of pixels contributing to a display of the right eye image in the same frame; and
a display data generator that generates display data used to display the left eye image and the right eye image alternately in time on the display module based on the left eye image display data and the right eye image display data.

4. The image display device according to claim 1, wherein:
the average brightness controller includes a display data generator that generates display data used to display left eye image display data and right eye image display data separately in time on the display module such that a number of times a left eye image is displayed in one given frame is different from a number of times a right eye image is displayed in the same frame.

5. The image display device according to claim 1, wherein:
the display module includes a backlight that illuminates a display screen, and the average brightness controller includes:
an image processor that generates left eye image display data and right eye image display data such that a maximum brightness of the left eye image in one given frame is equal to a maximum brightness of the right eye image in the same frame;
a display data generator that generates display data used to display the left eye image and the right eye image alternately in time on the display module based on the left eye image display data and the right eye image display data; and
a backlight controller that regulates a brightness of the backlight such that a brightness of the backlight generated when the left eye image is displayed in one given frame is different from a brightness of the backlight generated when the right eye image is displayed in the same frame.

6. The image display device according to claim 1, wherein:
the vision aid includes two shutters that can be opened and closed independently from each other, one at a left eye portion and the other at a right eye portion; and
the image display device includes a shutter controller that outputs, to the vision aid, a shutter control signal for controlling opening and closing of the shutters,
the shutter controller controlling the shutters such that an open time of one of the shutter of the left eye portion and the shutter of the right eye portion of the vision aid that corresponds to one of the left eye image and the right eye image that has a higher average brightness per frame is shorter than an open time of the other shutter.

7. The image display device according to claim 1, wherein:
the vision aid includes two shutters that can be opened and closed independently from each other and are each capable of controlling a light transmittance, one at a left eye portion and the other at the right eye portion; and
the image display device includes a shutter controller that outputs, to the vision aid, a shutter control signal for controlling opening and closing of the shutters,
the shutter controller controlling the shutters such that a light transmittance of one of the shutter of the left eye portion and the shutter of the right eye portion of the vision aid that corresponds to one of the left eye image and the right eye image that has a higher average brightness per frame is lower than a light transmittance of the other shutter.

8. The image display device according to claim 1, wherein:
the display module includes a first polarizing filter provided at a location that displays the left eye image and a second polarizing filter provided at a location that displays the right eye image and having a polarization property different from that of the first polarizing filter; and
the vision aid includes, at the left eye portion, a left eye polarizing filter that passes light that has passed through the first polarizing filter and, at the right eye portion, a right eye polarizing filter that passes light that has passed through the second polarizing filter.

9. The image display device according to claim 8, wherein:
the vision aid further includes a dark filter deposited on one of the left eye polarizing filter and the right eye polarizing filter of the vision aid that corresponds to one of the left eye image and the right eye image that has a higher average brightness per frame.

10. A stereo image display system including an image display device and a vision aid,
the image display device comprising:
a display module capable of displaying a left eye image to be viewed via a left eye portion of the vision aid and a right eye image to be viewed via a right eye portion of the vision aid, the left eye and right eye images being displayed separately in time and space; and
an average brightness controller capable of regulating an average brightness of the left eye image and an average brightness of the right eye image displayed on the display module in one given frame such that these average brightnesses are different from each other,
the vision aid including an image selector capable of allowing only the left eye image to pass through the left eye portion and allowing only the right eye image to pass through the right eye portion.

11. The stereo image display system according to claim 10, wherein:
the image selector of the vision aid includes two shutters that can be opened and closed independently from each other, one at a left eye portion and the other at a right eye portion; and
the image display device includes a shutter controller that outputs, to the vision aid, a shutter control signal for controlling opening and closing of the shutters,
the shutter controller controlling the shutters such that an open time of one of the shutter of the left eye portion and the shutter of the right eye portion of the vision aid that corresponds to one of the left eye image and the right eye image that has a higher average brightness per frame is shorter than an open time of the other shutter.

12. The stereo image display system according to claim 10, wherein:
the image selector of the vision aid includes two shutters that can be opened and closed independently from each other and are each capable of controlling a light transmittance, one at a left eye portion and the other at the right eye portion; and
the image display device includes a shutter controller that outputs, to the vision aid, a shutter control signal for controlling opening and closing of the shutters,
the shutter controller controlling the shutters such that a light transmittance of one of the shutter of the left eye portion and the shutter of the right eye portion of the vision aid that corresponds to one of the left eye image and the right eye image that has a higher average brightness per frame is lower than a light transmittance of the other shutter.

13. A vision aid including two shutters that can be opened and closed independently from each other, one at a left eye portion and the other at a right eye portion, comprising:
an image selector capable of allowing only a left eye image to pass through the left eye portion and allowing only a right eye image to pass through the right eye portion, the left eye image and the right eye image being displayed, on a display module of an image display device, separately in time and space so as to have different average brightnesses in one given frame.

14. The vision aid according to claim 13, wherein:
the image selector includes two shutters that can be opened and closed independently from each other in response to a shutter control signal output from the image display device, one shutter being located at the left eye portion and the other shutter at the right eye portion, and
an open time of one of the shutter of the left eye portion and the shutter of the right eye portion that corresponds to one of the left eye image and the right eye image that has a higher average brightness per frame is shorter than an open time of the other shutter.

15. The vision aid according to claim 13, wherein:
the image selector includes two shutters that can be opened and closed independently from each other and are each capable of controlling a light transmittance in response to a shutter control signal output from the image display device, one shutter being located at the left eye portion and the other shutter at the right eye portion, and
a light transmittance of one of the shutter of the left eye portion and the shutter of the right eye portion that corresponds to one of the left eye image and the right eye image that has a higher average brightness per frame is lower than a light transmittance of the other shutter.
